(19) United States
(12) Patent Application Publication
(10) Pub. No.: US 2018/0085774 A1
(43) Pub. Date: Mar. 29, 2018

(54) METHOD FOR MANUFACTURING MOLDED ARTICLE PROVIDED WITH GAS BARRIER LAYER

(71) Applicant: LINTEC CORPORATION, Tokyo (JP)

(72) Inventors: Satoshi NAGANAWA, Tokyo (JP); Yuta SUZUKI, Tokyo (JP); Takeshi KONDO, Tokyo (JP)

(21) Appl. No.: 15/561,027

(22) PCT Filed: Mar. 24, 2016
(86) PCT No.: PCT/JP2016/059311

§ 371 Date: Sep. 22, 2017

(30) Foreign Application Priority Data
Mar. 25, 2015 (JP) 2015-063204

(51) Int. Cl. B05C 9/14; B05C 5/02; B05C 13/02

(52) U.S. Cl. CPC B05C 9/14; B05D 3/0413; B05C 13/02; B05C 5/0245

(57) ABSTRACT

A manufacturing device is configured to manufacture a molded product provided with a gas barrier layer, in which the gas barrier layer is formed on a surface of the molded product. The manufacturing device includes: a coater configured to coat the molded product with the gas barrier material; a drier configured to dry the gas barrier material applied by the coater; a surface modifier configured to modify a surface of the gas barrier material dried by the drier; and a transfer unit configured to transfer the molded product to the coater, the drier, and the surface modifier. The coater, the drier, and the surface modifier are consecutively connected and separated from each other by partitions.

### CROSS REFERENCE

This application is the U.S. National Phase under 35 U.S.C. § 371 of International Application No. PCT/JP2016/059311, filed on Mar. 24, 2016, which claims the benefit of Japanese Application No. 2015-063204, filed on Mar. 25, 2015, the entire contents of each are hereby incorporated by reference.

### TECHNICAL FIELD

The present invention relates to a manufacturing device of a molded product provided with a gas barrier layer.

### BACKGROUND ART

In order to provide an alternative of a substrate in a form of glass used in an organic EL device, there have been typically proposed a manufacturing method and the like of a gas barrier film having an excellent gas barrier property in a short manufacturing time (see, for instance, Patent Literature 1).

More specifically, the manufacturing method of the gas barrier film includes: coating at least one surface of a base material with a polysilazane-containing liquid; heating and drying the base material to provide a polysilazane film; and subjecting the polysilazane film to an atmospheric pressure plasma processing or a vacuum plasma processing.

### CITATION LIST

### Patent Literature(s)

Patent Literature 1: JP2007-237588A

### SUMMARY OF THE INVENTION

### Problem(s) to be Solved by the Invention

In the technique disclosed in Patent Literature 1, since the coating step, the heating-drying step, and the vacuum plasma processing step are each independently performed, productivity is deteriorated and polysilazane in the coating liquid adversely reacts with moisture in the air to easily generate defects on the gas barrier film.

An object of the invention is to provide a manufacturing device configured to efficiently manufacture a molded product provided with a gas barrier layer (hereinafter, also referred to as a “gas barrier layer-formed product) having a favorable gas barrier property.

### Means for Solving the Problem(s)

According to an aspect of the invention, a manufacturing device of a molded product provided with a gas barrier layer, in which the gas barrier layer is formed on a surface of the molded product, includes: a coater configured to coat the molded product with a gas barrier material; a drier configured to dry the gas barrier material applied by the coater; a surface modifier configured to modify a surface of the gas barrier material dried in the drier, and a transfer unit configured to transfer the molded product to the coater, the drier, and the surface modifier, in which the coater, the drier, and the surface modifier are consecutively connected, and the coater, the drier, and the surface modifier are separated from each other by partitions.

With the manufacturing device according to the above aspect of the invention, since the coater, the drier, and the surface modifier are consecutively connected, the molded product can be transferred in a short time by the transfer unit, so that the molded product provided with the gas barrier layer can be efficiently manufactured.

Moreover, with the manufacturing device according to the above aspect of the invention, since a transfer time of the molded product is shortened, a reaction between the gas barrier layer and moisture in the air during the transfer is reducible, so that generation of defects or the like on the gas barrier layer is preventable.

In other words, in the above arrangement, a manufacturing device configured to efficiently manufacture a molded product provided with a gas barrier layer having a favorable gas barrier property can be provided.

In the manufacturing device according to the above aspect of the invention, preferably, the drier is disposed at a center of the manufacturing device, a transfer opening of the coater and a transfer opening of the surface modifier are positioned facing the drier, and the transfer unit is disposed in the drier.

With the above arrangement, after the gas barrier layer is formed on the surface of the molded product by the coater, drying of the gas barrier layer by the drier can be started simply by the transfer unit carrying the molded product out of the coater. Accordingly, the gas barrier layer can be dried in the drier during being transferred from the coater to the surface modifier, so that the gas barrier layer-formed product can be further efficiently manufactured.

In the manufacturing device according to the above aspect of the invention, preferably, a transfer opening of the coater, a transfer opening of the drier, and a transfer opening of the surface modifier face a space in which the transfer unit is disposed.

With the above arrangement, the same operation and the advantages as the above are obtainable.

In the manufacturing device according to the above aspect of the invention, preferably, the molded product is an elongated base material in a form of a roll, the transfer unit includes: a feeding roller configured to feed the elongated base material; and a winding roller configured to wind the elongated base material, the coater includes: a support roller supporting the elongated base material; and a die coater that is disposed opposite to the support roller across the elongated base material and is configured to coat the elongated base material with the gas barrier material, and the drier includes: a plurality of transfer rollers configured to transfer the elongated base material; and a heater disposed opposite to the plurality of transfer rollers across the elongated base material.

With the above arrangement, the elongated base material fed by the feeding roller can be coated with the gas barrier material by the die coater, and the gas barrier material can be dried on the transfer rollers by the heater, so that the gas barrier layer-formed product can be quickly manufactured.

In the manufacturing device according to the above aspect of the invention, preferably, the surface modifier includes: an electrode roller configured to be wound with the elongated base material; a voltage applying unit configured to apply a voltage onto the electrode roller; and an electrode disposed opposite to the electrode roller across the elongated base material.

With the above arrangement, since the surface modification of the gas barrier layer formed on the elongated base material can be conducted during the transfer of the elongated base material, all of the coating step, the drying step and the surface modification step can be continuously conducted during the transfer of the elongated base material, so that the molded product provided with the gas barrier layer can be more quickly manufactured.

In the manufacturing device according to the above aspect of the invention, preferably, the manufacturing device further includes a measuring unit configured to measure at least one of the gas barrier material applied by the coater, the gas barrier material dried by the drier, and the gas barrier material modified by the surface modifier.

With the above arrangement, the state of the gas barrier layer can be measured in a manufacture line after each of the coating step, the drying step, and the modification step (i.e., in-line measurement). By constantly controlling the film state in the manufacture line of the gas barrier layer-formed product, the film can be continuously evaluated and controlled and the molded product provided with the gas barrier layer can be continuously manufactured in a series from the coating of the gas barrier material to the ion injecting.

In the manufacturing device according to the above aspect of the invention, preferably, the measuring unit is consecutively connected to the coater, the drier, and the surface modifier, and the coater, the drier, the surface modifier, and the measuring unit are separated from each other by the partitions.

In the manufacturing device according to the above aspect of the invention, preferably, the measuring unit is disposed inside at least one of the coater, the drier, and the surface modifier.

With the above arrangement, since the coater, the drier, the surface modifier and the measuring unit are consecutively connected, the gas barrier layer-formed product can be efficiently manufactured in the same manner as described above even by the manufacturing device installed with the in-line measurement. Further, with the above arrangement, generation of defects and the like on the gas barrier layer is preventable in the same manner as described above.

In the manufacturing device according to the above aspect of the invention, the molded product is preferably transferred to the coater, the drier, and the measuring unit in this order.

With the above arrangement, since the molded product is transferred to the coater, the drier, and the measuring unit in this order, a state of the gas barrier layer before the surface modification is measurable. Accordingly, it can be checked before the surface modification whether the gas barrier layer is in a state suitable for the surface modification.

In the manufacturing device according to the above aspect of the invention, when the molded product is an elongated base material in a form of a roll, the measuring unit is also preferably disposed between the drier and the surface modifier.

With the above arrangement, since the measuring unit is interposed between the drier and the surface modifier, the state of the gas barrier layer before the surface modification is measurable. Accordingly, it can be checked before the surface modification whether the gas barrier layer formed on the elongated base material is in a state suitable for the surface modification.

In the manufacturing device according to the above aspect of the invention, the measuring unit preferably measures at least one selected from the group consisting of a refractive index, light transmissivity, light reflectivity, chromaticity, film composition, film density, film defects and film thickness of the gas barrier layer.

With the above arrangement, the film can be more suitably evaluated and controlled.

### BRIEF DESCRIPTION OF DRAWING(S)

FIG. 1 is a schematic cross-sectional view showing a structure of a gas barrier layer-formed product manufactured according to an exemplary embodiment of the invention.

FIG. 2 is a schematic plan view showing a structure of a manufacturing device of a molded product provided with a gas barrier layer according to a first exemplary embodiment of the invention.

FIG. 3 is a schematic side view showing a structure of a coater in the above exemplary embodiment.

FIG. 4 is a schematic side view showing a structure of a surface modifier in the above exemplary embodiment.

FIG. 5 is a schematic illustration showing a structure of a manufacturing device of a molded product provided with a gas barrier layer according to a second exemplary embodiment of the invention.

FIG. 6 is a schematic illustration showing a structure of a surface modifier in the above exemplary embodiment.

FIG. 7 is a schematic plan view showing a structure of a manufacturing device of a molded product provided with a gas barrier layer according to a third exemplary embodiment of the invention.

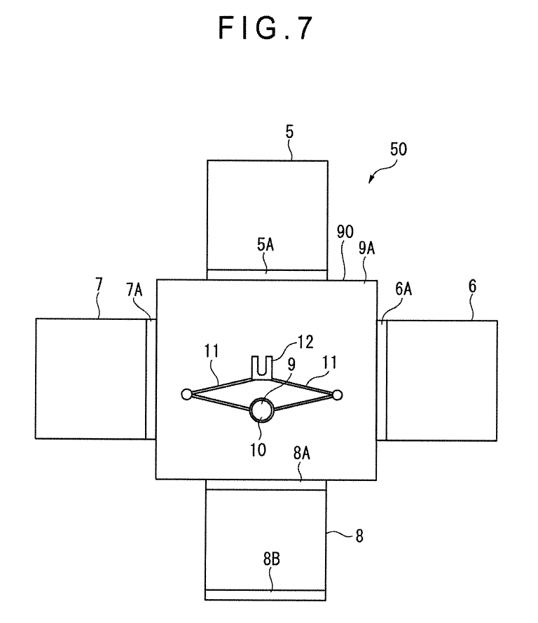

FIG. 8 is a schematic plan view showing a structure of a manufacturing device of a molded product provided with a gas barrier layer according to a fourth exemplary embodiment of the invention.

FIG. 9 is a schematic plan view showing a structure of a manufacturing device of a molded product provided with a gas barrier layer according to a fifth exemplary embodiment of the invention.

FIG. 10 is a schematic plan view showing a structure of a manufacturing device of a molded product provided with a gas barrier layer according to a sixth exemplary embodiment of the invention.

FIG. 11 is a schematic side view showing a structure of a coater in the sixth exemplary embodiment.

FIG. 12 is a schematic side view showing a structure of a surface modifier in the sixth exemplary embodiment.

FIG. 13 is a schematic illustration showing a structure of a manufacturing device of a molded product provided with a gas barrier layer according to a seventh exemplary embodiment of the invention.

### DESCRIPTION OF EMBODIMENT(S)

Exemplary embodiments of the invention will be described below with reference to the attached drawings.

### [1] Structure of Gas Barrier Layer-Formed Product

A gas barrier layer-formed product is a molded product provided with a gas barrier layer. The gas barrier layer is preferably formed at any portion of the molded product. The portion where the gas barrier layer is formed is appropriately selected according to usage of the gas barrier layer-formed product. For instance, the gas barrier layer is preferably formed on a surface of the molded product.

The molded product may be of any nature. Examples of the molded product include plate-like components, various containers and various electronic device components. Examples of the plate-like components include a film, sheet and plate. Examples of the various containers include a food container, drink container, cosmetics container, clothing item container, medicine container, and bottles such as a food bottle, drink bottle, cooking oil bottle, and seasoning bottle. Examples of the electronic device components include an organic EL device, liquid crystal device, quantum dot device, electronic paper device, organic solar cell device, thin-film battery, organic thin-film transistor device, organic sensor device and Micro Electro Mechanical Systems (MEMS) device. In the exemplary embodiments, even a thin plate-like component and an elongated plate-like component are usable as the molded product.

A gas barrier film will be described below as an example of the gas barrier layer-formed product.

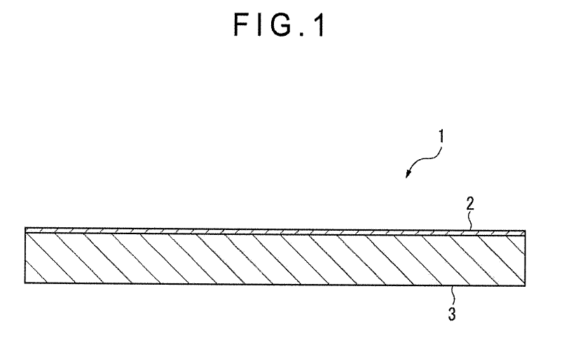

FIG. 1 shows a gas barrier film 1 according to an exemplary embodiment of the invention. The gas barrier film 1 is manufactured by forming a gas barrier layer 2 on a molded product 3.

The gas barrier layer 2 is formed of polysilazane to have a thickness approximately from 10 nm to 500 nm.

When the thickness of the polysilazane layer is approximately from 10 nm to 500 nm, a refractive index of the gas barrier layer 2 is easily controllable and the gas barrier layer 2 is stably formable to provide the gas barrier film 1 having an excellent gas barrier property and an excellent transparency (total light transmissivity).

When the thickness of the polysilazane layer is approximately from 10 nm to 500 nm, the gas barrier layer 2 exhibits an excellent flexibility and a favorable adherence to the molded product.

When the thickness of the polysilazane layer is less than 10 nm, it is sometimes difficult to control the thickness to be uniform and/or to control the refractive index.

Moreover, when the thickness of the polysilazane layer is less than 10 nm, a mechanical strength of the gas barrier film 1 is sometimes decreased and a steam transmissivity is sometimes increased to provide an insufficient gas barrier property.

On the other hand, when the thickness of the polysilazane layer exceeds 500 nm, it is sometimes difficult to control the refractive index. Further, when the gas barrier film 1 has the gas barrier layer in a form of the polysilazane layer having the thickness exceeding 500 nm, flexibility of the gas barrier film 1 is sometimes excessively decreased, adherence between the gas barrier layer 2 and the molded product 3 and the like is sometimes excessively decreased, and transparency of the gas barrier layer 2 is sometimes excessively decreased.

A polysilazane material used for forming the polysilazane layer is a polymer compound having a repeating unit including a bond of —Si—N— (silazane bond) in a molecule.

Specifically, a polysilazane compound is preferably a compound having a repeating unit represented by a formula (1) below.

A number average molecular weight of the polysilazane compound to be used is not particularly limited. The number average molecular weight of the polysilazane compound preferably ranges from 100 to 50000.

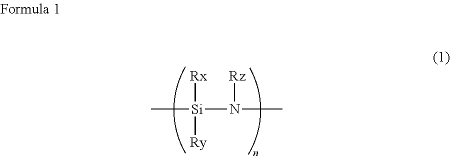

In the formula (1), Rx, Ry and Rz each independently represent a hydrogen atom or a non-hydrolyzable group such as a substituted or unsubstituted alkyl group, a substituted or unsubstituted cycloalkyl group, a substituted or unsubstituted alkenyl group, a substituted or unsubstituted aryl group, or an alkylsilyl group. A suffix “n” represents any natural number.

Examples of the alkyl group in the above “substituted or unsubstituted alkyl group” include alkyl groups having 1 to 10 carbon atoms such as a methyl group, ethyl group, n-propyl group, isopropyl group, n-butyl group, isobutyl group, sec-butyl group, t-butyl group, n-pentyl group, isopentyl group, neopentyl group, n-hexyl group, n-heptyl group, and n-octyl group.

Examples of the cycloalkyl group in the above “substituted or unsubstituted cycloalkyl group” include cycloalkyl groups having 3 to 10 carbon atoms such as a cyclobutyl group, cyclopentyl group, cyclohexyl group, and cycloheptyl group.

Examples of the alkenyl group in the above “substituted or unsubstituted alkenyl group” include alkenyl groups having 2 to 10 carbon atoms such as a vinyl group, 1-propenyl group, 2-propenyl group, 1-butenyl group, 2-butenyl group, and 3-butenyl group.

Examples of a substituent that may substitute the alkyl group, cycloalkyl group, and alkenyl group include: halogen atom such as a fluorine atom, chlorine atom, bromine atom, and iodine atom; hydroxyl group; thiol group; epoxy group; glycidoxy group; (meth)acryloyloxy group; a substituted or unsubstituted aryl group such as a phenyl group, 4-methylphenyl group, and 4-chlorophenyl group.

Examples of the above substituted or unsubstituted aryl group include aryl groups having 6 to 10 carbon atoms such as a phenyl group, 1-naphthyl group, and 2-naphthyl group.

Examples of a substituent that may substitute the aryl group include: halogen atom such as a fluorine atom, chlorine atom, bromine atom, and iodine atom; an alkyl group having 1 to 6 carbon atoms such as a methyl group and ethyl group; an alkoxy group having 1 to 6 carbon atoms such as a methoxy group and ethoxy group; nitro group; cyano group; hydroxyl group; thiol group; epoxy group; glycidoxy group; (meth)acryloyloxy group; a substituted or unsubstituted aryl group such as a phenyl group, 4-methylphenyl group, and 4-chlorophenyl group.

Examples of the alkylsilyl group include a trimethylsilyl group, triethylsilyl group, triisopropylsilyl group, tri-t-butylsilyl group, methyldiethylsilyl group, dimethylsilyl group, diethylsilyl group, methylsilyl group, and ethylsilyl group.

Among the above examples, Rx, Ry and Rz are preferably each independently a hydrogen atom, an alkyl group having 1 to 6 carbon atoms, or a phenyl group, particularly preferably a hydrogen atom.

The polysilazane compound having the repating unit represented by the formula (1) is preferably an inorganic polysilazane compound in which all of Rx, Ry and Rz are hydrogen atoms.

The molded product 3 may be of any nature. When the molded product 3 is in a form of a plate-like component, one or a combination of two or more of the plate-like components selected from the group consisting of a glass plate, ceramic plate, thermoplastic resin film, thermosetting resin film and photo-curable resin film may be used. Examples of the thermoplastic resin film include a polyester film, polyolefin film, polycarbonate film, polyimide film, polyamide film, polyamideimide film, polyphenylene ether film, polyether ketone film, polyether ether ketone film, polysulfone film, polyethersulfone film, polyphenylene sulfide film, polyarylate film, acryl resin film, cycloolefin polymer film, and aromatic polymer film. Examples of the thermosetting resin film include an epoxy resin film, silicone resin film, and phenol resin film. Examples of the photo-curable resin film include a photo-curable acrylic resin film, photo-curable urethane resin film, and photo-curable epoxy resin film.

A thickness of the molded product 3 in a form of a plate and a film is not particularly limited. The thickness of the molded product 3 preferably typically ranges from 0.5 μm to 1000 μm, more preferably from 1 μm to 300 μm, further preferably from 5 μm to 200 μm.

Among the examples, in view of an excellent transparency and versatility, the molded product 3 is preferably a polyester film, polyamide film, polyimide film, polyamideimide film, polysulfone film, polyether sulfone film, polyphenylene sulfide film, polyarylate film or cycloolefin polymer film, more preferably a polyester film, polyamide film or cycloolefin polymer film.

Specific examples of the polyester film include films made of polyethylene terephthalate, polybutylene terephthalate, polyethylene naphthalate, polyarylate or the like.

Specific examples of the polyamide film include films made of all aromatic polyamides, nylon 6, nylon 66, or nylon copolymer.

### [2] First Exemplary Embodiment

A first exemplary embodiment of a manufacturing device and a manufacturing method of a gas barrier film 1 as a gas barrier layer-formed product will be described. The manufacturing device of the gas barrier film is also usable as a manufacturing device of a gas barrier layer.

### Manufacturing Device of Gas Barrier Film

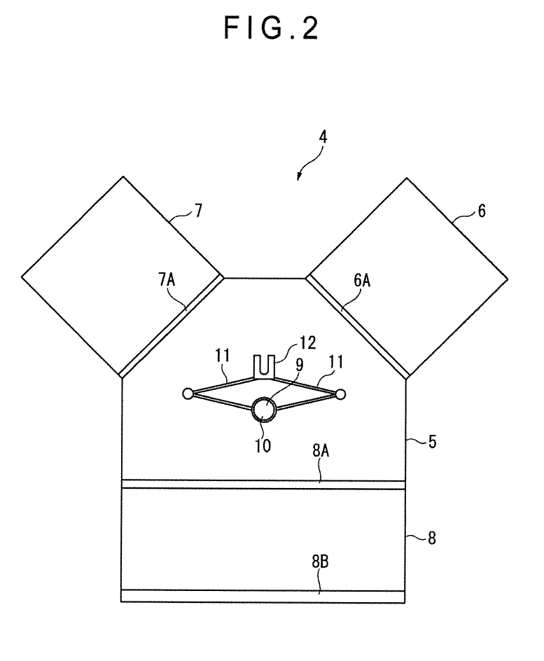

FIG. 2 schematically shows a plan view of a manufacturing device 4 of the gas barrier film according to the first exemplary embodiment. The manufacturing device 4 of the gas barrier film includes a drier 5 set in the middle of the manufacturing device, a coater 6, a surface modifier 7, and a load lock chamber 8.

In the manufacturing device 4 of the gas barrier film, the coater 6, the drier 5, the surface modifier 7, and the load lock chamber 8 are consecutively connected.

Each of the coater 6, the surface modifier 7, and the load lock chamber 8 includes an opening for loading and unloading the molded product 3 (hereinafter, also referred to as a “transfer opening”). The respective openings of the coater 6, the surface modifier 7, and the load lock chamber 8 are disposed facing the drier 5. The openings of the coater 6, the surface modifier 7, and the load lock chamber 8 are respectively blocked with a gate shutter 6A, a gate shutter 7A, and a gate shutter 8A which are openable and closeable partitions with respect to the drier 5.

The drier 5 is configured to dry the gas barrier layer 2 formed of the gas barrier material applied by the coater 6.

A transfer robot 9 as a transfer unit is disposed at the center of the drier 5. The transfer robot 9 includes: a column 10 rotatable by a motor (not shown); a pair of arms 11 horizontally projecting from the column 10; and a platform 12 attached to leading ends of the arms 11.

The pair of arms 11 are expandable in a direction away from the column 10. By expanding the arms 11, the molded product 3 of the gas barrier film 1, which is mounted on the platform 12, can be carried into the coater 6, the surface modifier 7, and the load lock chamber 8.

The load lock chamber 8 is connected to the drier 5. The load lock chamber 8 includes: an opening provided facing the drier 5; and a transfer gate 8B. The opening of the load lock chamber 8 is blocked with the gate shutter 8A as a partition. In order to carry the molded product 3 into the manufacturing device 4, the molded product 3 is carried through the transfer gate 8B and a door of the transfer gate 8B is closed, and subsequently, the gate shutter 8A facing the drier 5 is opened and the molded product 3 is carried by the transfer robot 9.

The coater 6 is configured to coat the molded product 3 with the gas barrier material to form the gas barrier layer 2. The coater 6 is connected to the drier 5. The gas barrier layer 2 before being subjected to heating is sometimes referred to as a gas barrier material layer or a polysilazane layer.

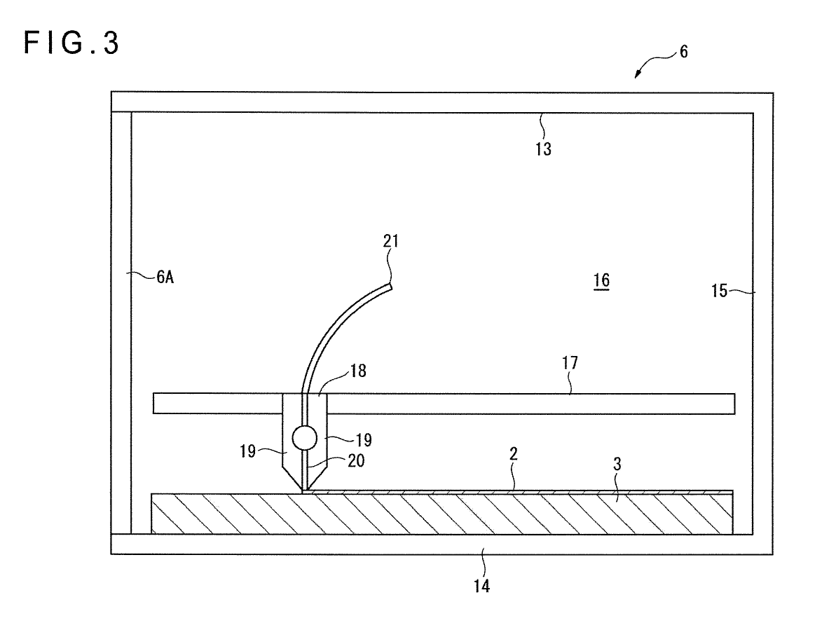

As shown in FIG. 3, the coater 6 includes a top board 13, a bottom board 14, a backboard 15, and a pair of sideboards 16. The coater 6 has an opening facing the drier 5. The opening of the coater 6 is blocked with the gate shutter 6A as a partition.

An inside of the coater 6 is isolated from an outside. Since the inside of the coater 6 is isolated from the outside, undesired dust and the like can be prevented from adhering on the molded product 3 when the gas barrier layer 2 is formed on the molded product 3. In order to prevent a progress of a polysilazane conversion reaction in the inside of the coater 6 isolated from the outside, the gas barrier material is applied at an atmospheric pressure under nitrogen atmosphere.

A pair of rails 17 are provided to the respective sideboards 16 in the coater 6. A die coater 18 is slidably attached to the pair of rails 17.

The die coater 18 is configured to slide on the rails 17 by a drive motor (not shown). The die coater 18 includes a pair of dies 19 having narrow leading ends. A lip 20 is defined between the pair of dies 19. The gas barrier material such as polysilazane is applied through the lip 20 to a surface of the molded product 3. An interval between the pair of dies 19 is adjustable. A coating amount of the gas barrier material is adjustable by adjusting a width of the lip 20.

The gas barrier material is fed into the lip 20 through a delivery hose 21. Specifically, the gas barrier material is fed into the lip 20 through the delivery hose 21 from a tank (not shown) storing the gas barrier material by a pump configured to transfer the gas barrier material from the tank.

In order to apply the gas barrier layer 2 at a uniform thickness, for instance, it is preferable to blend an organic solvent and the like with a polysilazane compound to provide a liquid and apply the liquid onto the molded product 3.

A coating method of the gas barrier material onto the molded product 3 in the coater 6 is not limited to the above method. As the coating method of the gas barrier material, various known methods such as a screen printing, knife coating, roll coating, inkjet coating, spin coating, spray coating, gravure coating and bar coating may be used.

Heating conditions in the drier 5 preferably include a heating temperature ranging from 50 degrees C. to 200 degrees C. and a heating time ranging from 30 seconds to 60 minutes.

By setting such heating conditions, the gas barrier layer 2 formed of polysilazane can be dried to form a film without damaging the molded product 3 and the like, so that the gas barrier film 1 having an extremely excellent gas barrier property can be stably produced. The heating conditions more preferably include the heating temperature ranging from 60 degrees C. to 180 degrees C. and the heating time ranging from 1 minute to 50 minutes, further preferably the heating temperature ranging from 70 degrees C. to 150 degrees C. and the heating time ranging from 2 minutes to 30 minutes. The heating conditions in the drier 5 are not limited to the above conditions. Various drying units are usable as the drier 5 as long as being capable of drying the gas barrier layer 2. Examples of the drying units include a hot air heater and an IR heater. The gas barrier layer 2 dried by the drier 5 is sometimes referred to as a modified polysilazane layer. In order to control a polysilazane conversion reaction in the drier 5, the gas barrier material is dried at the atmospheric pressure under nitrogen atmosphere or under humidified atmosphere.

The surface modifier 7 is configured to modify a surface of the gas barrier layer 2 (a modified polysilazane layer) dried by the drier 5. The surface modifier 7 injects plasma ions into the gas barrier layer 2 to modify the surface of the gas barrier layer 2.

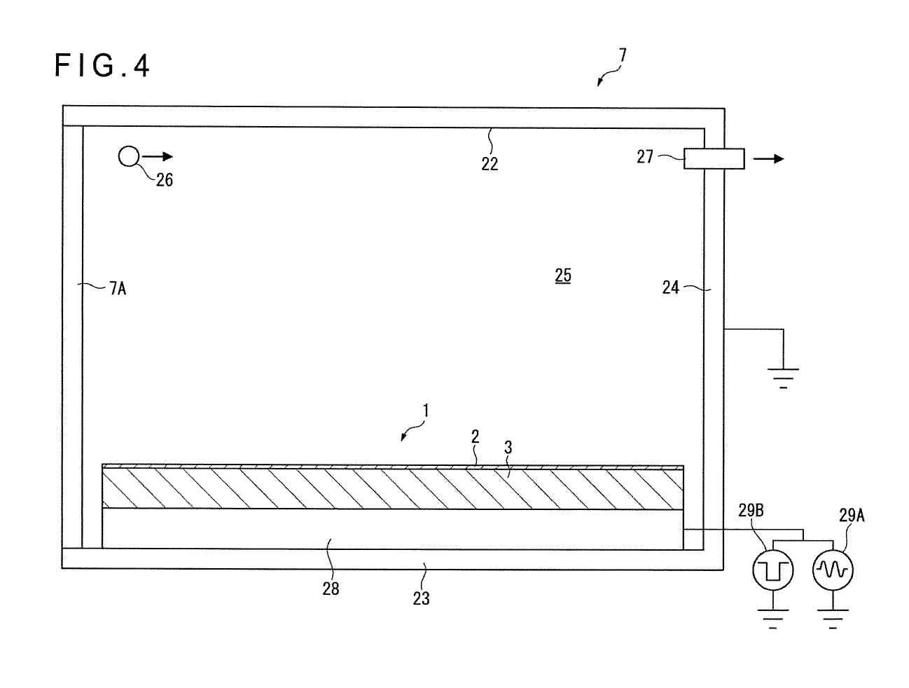

As shown in FIG. 4, the surface modifier 7 includes a chamber including a top board 22, a bottom board 23, a backboard 24, and a pair of sideboards 25 opposed to each other. The surface modifier 7 is connected to the drier 5. The surface modifier 7 has an opening facing the drier 5. The opening of the surface modifier 7 is blocked with the gate shutter 7A as a partition.

An inside of the surface modifier 7 is isolated from the outside. A gas inlet 26 penetrating the surface modifier 7 is provided on one of the sideboards 25 of the surface modifier 7. An exhaust outlet 27 is provided at an upper part of the backboard 24.

An electrode 28 is provided in the inside of the surface modifier 7. A high-frequency power source 29A and a high-voltage pulse power source 29B are connected as a voltage applying unit to the electrode 28. The top board 22, the bottom board 23, the backboard 24, and the pair of sideboards 25 are made of a metallic plate and grounded.

A basic method of injecting plasma ions using the surface modifier 7 is exemplified by a method of injecting ions (cations) present in plasma onto a surface of the modified polysilazane layer, the method including plasma generation under atmosphere containing a plasma generation gas (e.g., noble gas) and application of a negative high voltage pulse.

Specifically, gas is injected through the gas inlet 26 into the chamber, the high-frequency power source 29A is turned on to generate plasma on the surface of the gas barrier layer 2 and subsequently the high-voltage pulse power source 29B is turned on to apply a high voltage to the electrode 28, thereby injecting plasma ions.

The ions injected to the gas barrier layer 2 may be of any nature. Examples of the ions injected to the gas barrier layer 2 include ions shown in (a) to (k) below.

(a) ions of noble gases such as argon, helium, neon, krypton and xenon;
(b) ions of fluorocarbon, hydrogen, nitrogen, oxygen, carbon dioxide, chlorine, water, fluorine and sulfur; and ammonia;
(a) ions of alkane gases such as methane, ethane, propane, butane, pentane and hexane;
(d) ions of alkene gases such as ethylene, propylene, butene and pentene;
(e) ions of alkadiene gases such as pentadiene and butadiene;
(f) ions of alkyne gases such as acetylene and methyl acetylene;
(g) ions of aromatic hydrocarbon gases such as benzene, toluene, xylene, indene, naphthalene and phenanthrene;
(h) ions of cycloalkane gases such as cyclopropane and cyclohexane;
(i) ions of cycloalkene gases such as cyclopentene and cyclohexane;
(j) ions of conductive metals such as gold, silver, copper, platinum, nickel, palladium, chrome, titanium, molybdenum, niobium, tantalum, tungsten and aluminum; and
(k) ions of silane (SiH₄) or an organic silicon compound.

Among the above ions, the ions of at least one selected from the group consisting of hydrogen, nitrogen, oxygen, water, argon, helium, neon, xenon and krypton are preferable since the ions can be more easily injected to a predetermined depth of the gas barrier layer 2 to obtain the gas barrier film 1 stably having an excellent gas barrier property even though the gas barrier film 1 is a thin film.

A pressure for injecting the plasma ions into the chamber when injecting the ions is preferably in a range from 0.01 Pa to 1 Pa.

When the pressure for injecting the plasma ions falls within the above range, the ions can be injected easily, efficiently and uniformly, so that the gas barrier film 1 having both of flexural resistance and gas barrier property can be efficiently formed.

The pressure for injecting the plasma ions is more preferably in a range from 0.02 Pa to 0.8 Pa, further preferably in a range from 0.03 Pa to 0.6 Pa.

A voltage applied when injecting the ions is preferably in a range from −1 kV to −50 kV.

Next, an operation of the manufacturing device 4 of the gas barrier film according to the first exemplary embodiment will be described. It should be noted that the molded product 3 in the first exemplary embodiment is a thin plate-like component (film).

A controller (not shown) such as a computer is connected to the manufacturing device 4 of the gas barrier film. The controller is configured to perform not only a typical transfer process control of a semiconductor manufacturing device but also a coating amount control to adjust an opening size of the lip 20 of the die coater 18 in the coater 6, humidity adjustment and temperature control in the drier 5, and an electrode adjustment control and applied voltage adjustment control in the surface modifier 7.

### Manufacturing Method of Gas Barrier Film

In a manufacturing method of the gas barrier layer-formed product (gas barrier film 1) according to the exemplary embodiment, the manufacturing device 4 of the gas barrier film is used as a gas barrier layer-manufacturing device.

The manufacturing method of the gas barrier film 1 according to the exemplary embodiment includes: coating the surface of the molded product 3 with the gas barrier material in the coater 6; subsequently carrying the molded product 3 coated with the gas barrier material into the drier 5; drying the applied gas barrier material in the drier 5; carrying the molded product 3 to the surface modifier 7 after the gas barrier material is dried; and modifying a surface of the dried gas barrier material in the surface modifier 7.

An example of the manufacturing method of the gas barrier film 1 using the manufacturing device 4 of the gas barrier film will be described below.

Firstly, the molded product 3 is fed to the load lock chamber 8 through the transfer gate 8B and a door of the transfer gate 8B is closed. After the door is closed, the gate shutter 8A is opened and the molded product 3 is carried out of the load lock chamber 8 by the transfer robot 9. The transfer robot 9 revolves to carry the molded product 3 to a front of the coater 6. After the gate shutter 6A of the coater 6 is opened, the transfer robot 9 carries the molded product 3 to an inside of the coater 6.

After the molded product 3 is placed at a predetermined position inside the coater 6, the gate shutter 6A is closed and the die coater 18 slides along the rails 17 and coats the surface of the molded product 3 with the gas barrier material to form the gas barrier layer 2.

After the gas barrier layer 2 is formed, the gate shutter 6A is opened, the transfer robot 9 carries the molded product 3 out of the coater 6 to the drier 5 and holds the molded product 3 in the drier 5 for a predetermined time to dry the gas barrier material of the gas barrier layer 2.

After the molded product 3 is dried by the drier 5, the transfer robot 9 transfers the molded product 3 to the front of the surface modifier 7. When the gate shutter 7A is opened, the transfer robot 9 carries the molded product 3 into the surface modifier 7. After the molded product 3 is loaded, an argon gas or the like is injected into the surface modifier 7 through the gas inlet 26 while air inside the surface modifier 7 is removed through the exhaust outlet 27, and the high-frequency power source 29A and the high-voltage pulse power source 29B apply voltage, thereby injecting plasma ions.

After the plasma ions are injected, air is injected into the surface modifier 7. When an internal pressure of the surface modifier 7 reaches the atmospheric pressure, the transfer robot 9 carries the molded product 3 out of the surface modifier 7 and carries the molded product 3 into the load lock chamber 8. An operator takes out the molded product 3 having the gas barrier layer 2 (i.e., the gas barrier film 1) through the transfer gate 8B.

According to the exemplary embodiment, the following advantages are obtainable.

Since the coater 6, the drier 5, and the surface modifier 7 are consecutively connected, the molded product 3 can be transferred in a short time by the transfer robot 9, so that the gas barrier film 1 can be efficiently manufactured.

Moreover, since a transfer time of the molded product 3 is shortened, it is reducible for the gas barrier layer 2 to react with moisture in the air during the transfer, so that generation of defects or the like on the gas barrier layer 2 is preventable.

In short, with the manufacturing device and the manufacturing method according to the exemplary embodiment, a gas barrier film having a favorable gas barrier property can be manufactured.

After the gas barrier layer 2 is formed on the surface of the molded product 3 by the coater 6, drying of the gas barrier layer 2 by the drier 5 can be started simply by the transfer robot 9 carrying the molded product 3 out of the coater 6. Accordingly, the gas barrier layer 2 can be dried in the drier 5 during being transferred from the coater 6 to surface modifier 7, so that the gas barrier film 1 can be further efficiently manufactured.

### [3] Second Exemplary Embodiment

Next, a second exemplary embodiment of the invention will be described. It should be noted that an explanation of components identical to the components already explained will be omitted herein below.

### Manufacturing Device of Gas Barrier Film

In the first exemplary embodiment, the thin molded product 3 is transferred to the coater 6, the drier 5, and the surface modifier 7 using the transfer robot 9, thereby coating, drying and surface-modifying the gas barrier layer 2.

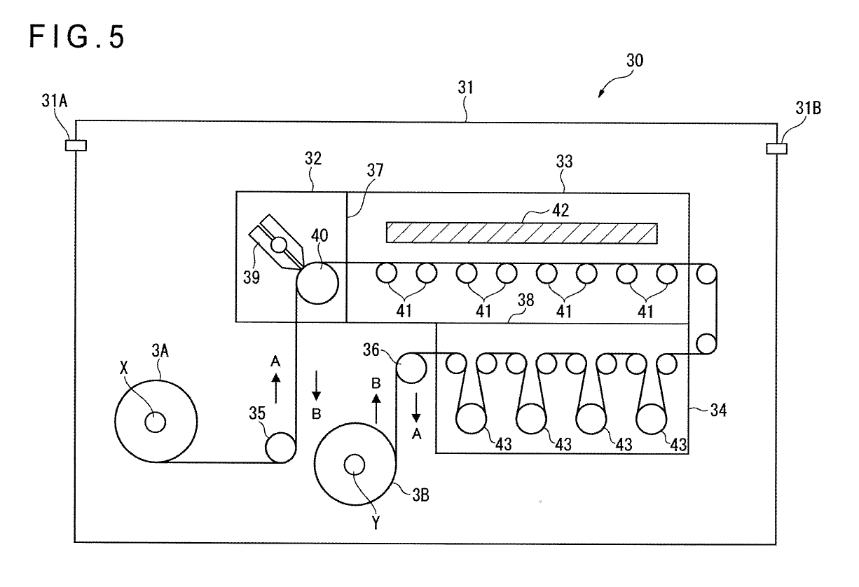

However, a manufacturing device 30 of a gas barrier film according to the second exemplary embodiment is different from the manufacturing device 4 of the gas barrier film according to the first exemplary embodiment in that the manufacturing device 30 manufactures the gas barrier film by a so-called roll-to-roll method. As shown in FIG. 5, the manufacturing device 30 of the gas barrier film in the exemplary embodiment transfers an elongated base material 3A and an elongated base material 3B, which are rolled as a molded product, using a drive roller 35 and a drive roller 36. During the transfer, the elongated base material 3A and the elongated base material 3B are subjected to processings in a coater 32, a drier 33, and a surface modifier 34. It should be noted that the elongated base material 3A and the elongated base material 3B are the molded product in a form of a film. The word of “elongated” means, for instance, that a length of the material is ten times or more as long as a width thereof.

As shown in FIG. 5, the manufacturing device 30 of the gas barrier film in the exemplary embodiment includes a chamber 31, the coater 32, the drier 33, the surface modifier 34, the drive roller 35, the drive roller 36, a partition 37, and a partition 38.

The manufacturing device 30 is entirely housed in the chamber 31. Specifically, the coater 32, the drier 33, the surface modifier 34, the drive roller 35, the drive roller 36, the partition 37, and the partition 38 are housed in the chamber 31.

The chamber 31 has a gas inlet 31A and an exhaust outlet 31B each penetrating the chamber 31. When feeding the base materials in A direction in FIG. 5, since the base materials are subjected to coating and drying, an inside of the chamber 31 is at the atmospheric pressure under nitrogen atmosphere. On the other hand, when feeding the base materials in B direction in FIG. 5, since plasma ions are injected, the inside of the chamber 31 is at a low pressure under argon atmosphere. Conditions for each of the coating, drying and injecting plasma ions are the same as those in the first exemplary embodiment.

The coater 32 includes a die coater 39 and a backup roller 40 as a support roller. The elongated base material 3A is wound around the backup roller 40. The die coater 39 is disposed opposite to the backup roller 40 across the elongated base material 3A. The die coater 39 coats the elongated base material 3A with the gas barrier material.

The drier 33 includes a plurality of transfer rollers 41 and a heater 42.

The plurality of transfer rollers 41 transfer the elongated base material 3A wound around a winding shaft X.

The plurality of transfer rollers 41 are disposed opposite to the heater 42 across the elongated base material 3A. The gas barrier layer on the elongated base material 3A is dried by heat of the heater 42.

The number of the transfer rollers 41 and a length of the heater 42 may be determined as needed according to a feeding speed of the elongated base material 3A and a heating temperature of the heater 42.

The surface modifier 34 includes a plurality of plasma ion injecting units 43 as described in detail later. The surface modifier 34 is configured to inject plasma ions into the gas barrier layer formed on the elongated base material 3A.

It should be noted that coating conditions in the coater 32, drying conditions in the drier 33, and surface-modifying conditions in the surface modifier 34 are the same as those in the first exemplary embodiment.

Each of the drive roller 35 and the drive roller 36 has a drive motor (not shown) at its shaft. The elongated base material 3A in a roll can be fed by the drive roller 35 in the A direction and can be wound around a winding shaft Y by the drive roller 36. When feeding the elongated base material 3A in the A direction, the drive roller 35 serves as a feeding roller and the drive roller 36 serves as a winding roller. The elongated base material 3B can be fed by the drive roller 36 in the B direction and can be wound around a winding shaft X by the drive roller 35. When feeding the elongated base material 3B in the B direction, the drive roller 35 serves as a winding roller and the drive roller 36 serves as a feeding roller.

The partition 37 is provided between the coater 32 and the drier 33. The partition 38 is provided between the drier 33 and the surface modifier 34. Processing units (the coater 32, the drier 33 and the surface modifier 34) are separated from each other with the partition 37 and the partition 38. Each of the partition 37 and the partition 38 has a slit through which the elongated base material 3A and the elongated base material 3B pass.

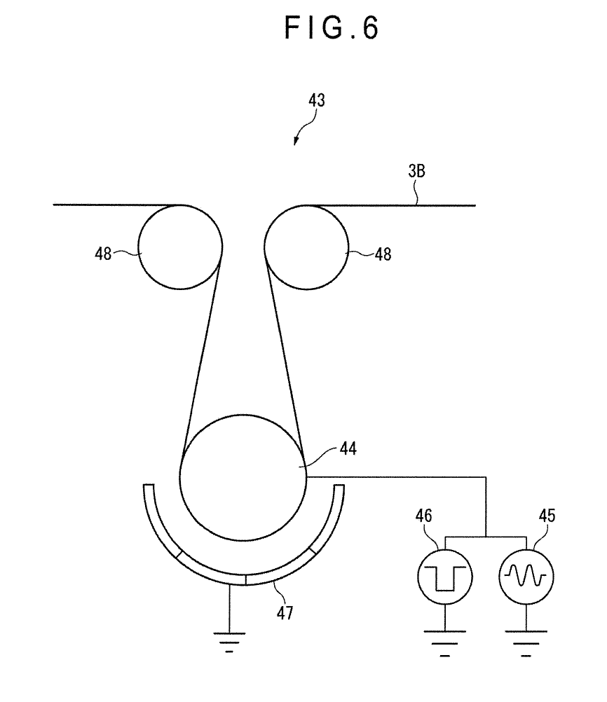

Each of the plasma ion injecting units 43 forming the surface modifier 34 includes an electrode roller 44, a high-frequency power source 45, a high-voltage pulse power source 46, an electrode member 47 (electrode), and a guide roller 48 as shown in FIG. 6.

The elongated base material 3B is wound around the electrode roller 44. The electrode roller 44 is electrically connected to the high-frequency power source 45 and the high-voltage pulse power source 46 which serve as a voltage applying unit. A structure and an operation of each of the high-frequency power source 45 and the high-voltage pulse power source 46 are the same as those in the first exemplary embodiment.

The electrode member 47 is disposed opposite to the electrode roller 44 across the elongated base material 3B. The electrode member 47 is disposed along an outer circumference of the electrode roller 44 in a manner to surround the electrode roller 44. The electrode member 47 is grounded.

The guide roller 48 is configured to introduce the elongated base material 3B to the electrode roller 44 and guide the elongated base material 3B to the next one of the plasma ion injecting units 43.

In the exemplary embodiment, a plurality of plasma ion injecting units 43 are used. The number of the plasma ion injecting units 43 may be set as needed according to a required frequency of injecting plasma ions.

Next, an operation of the second exemplary embodiment will be described.

A controller such as a computer is connected to the manufacturing device 30 of the gas barrier film. The controller is configured to perform not only feeding and winding control of the elongated base material 3A and the elongated base material 3B and a coating amount control of the gas barrier material in the coater 32 but also humid adjustment and temperature control in the drier 33, and an electrode adjustment control and applied voltage adjustment control in the surface modifier 7.

### Manufacturing Method of Gas Barrier Film

In a manufacturing method of the gas barrier layer-formed product (an elongated gas barrier film) according to the exemplary embodiment, the manufacturing device 30 of the gas barrier film is used as a gas barrier layer-manufacturing device.

The manufacturing method of the gas barrier film according to the exemplary embodiment includes: feeding the elongated base material 3A; coating the surface of the elongated base material 3A with the gas barrier material in the coater 32; carrying the elongated base material 3A coated with the gas barrier material into the drier 33; drying the coated gas barrier material in the drier 33; winding the elongated base material 3A after the gas barrier material is dried; subsequently feeding the wound elongated base material 3A as the elongated base material 3B; carrying the elongated base material 3B to the surface modifier 34; and modifying a surface of the dried gas barrier material in the surface modifier 34. After drying the gas barrier material and before modifying the surface, a step of changing an atmosphere inside the gas barrier layer-manufacturing device from the atmosphere in the drying is preferably performed. Changing of the atmosphere inside the gas barrier layer-manufacturing device is exemplified by changing a nitrogen atmosphere to an argon atmosphere.

An example of the manufacturing method of the elongated gas barrier film using the manufacturing device 30 of the gas barrier film will be described below.

Firstly, an inside of the chamber 31 is set at the atmospheric pressure under nitrogen atmosphere. Next, the drive roller 35 is rotated in the feeding direction to feed the elongated base material 3A, which is wound around the winding shaft X, in the A direction. The die coater 39 of the coater 32 coats the elongated base material 3A with the gas barrier material. After coating of the gas barrier material, the gas barrier layer is dried by the heater 42 of the drier 33. The elongated base material 3A is wound around the winding shaft Y by the drive roller 36.

Next, after the inside of the chamber 31 is changed to a low pressure under argon atmosphere, a rotation direction of the drive roller 36 is reversed to feed the elongated base material 3B, which is wound around the winding shaft Y, in the B direction.

The surface modifier 34 injects plasma ions into the gas barrier layer on the elongated base material 3B to modify the surface of the gas barrier layer.

After the surface is modified, the elongated base material 3B is wound around the winding shaft X by the drive roller 35.

In case where a plurality of gas barrier layers are layered, the above steps are repeated according to the number of the layers.

According to the second exemplary embodiment, the following advantages are obtainable in addition to the above-described advantages of the first exemplary embodiment.

With the manufacturing device and the manufacturing method according to the second exemplary embodiment, the die coater 39 can continuously coat the elongated base material 3A fed by the drive roller 35 with the gas barrier material, the heater 42 can dry the gas barrier material on the transfer rollers 41, and the high-frequency power source 45 and the high-voltage pulse power source 46 can modify the surface of the gas barrier layer on the elongated base material 3B fed by the drive roller 36. Accordingly, with the manufacturing device and the manufacturing method according to the exemplary embodiment, a gas barrier film can be manufactured continuously and quickly.

### [4] Third Exemplary Embodiment

Next, a third exemplary embodiment of the invention will be described. It should be noted that an explanation of components identical to the components already explained will be omitted herein below.

### Manufacturing Device of Gas Barrier Film

In the first exemplary embodiment, a space where the transfer robot 9 is disposed also functions as the drier 5. In the first exemplary embodiment, the transfer robot 9 as the transfer unit is housed in the drier 5.

In contrast, a manufacturing device 50 of a gas barrier film according to the third exemplary embodiment is different from the manufacturing device 4 of the gas barrier film according to the first exemplary embodiment in that the drier 5 is independent of a space 9A where the transfer robot 9 is disposed.

The manufacturing device 50 of the gas barrier film includes a transfer chamber 90 provided in the middle of the manufacturing device, the drier 5, the coater 6, the surface modifier 7, and the load lock chamber 8.

An inside of the transfer chamber 90 is defined as the space 9A. The transfer robot 9 is disposed in the space 9A. A pair of arms of the transfer robot 9 are expandable in a direction away from the column 10. By expanding the arms 11, the molded product 3 mounted on the platform 12 can be carried into the drier 5, the coater 6, the surface modifier 7, and the load lock chamber 8.

In the manufacturing device 50 of the gas barrier film, the transfer chamber 90, the coater 6, the drier 5, the surface modifier 7, and the load lock chamber 8 are consecutively connected.

The drier 5 is connected to the transfer chamber 90. The drier 5 has an opening facing the space 9A of the transfer chamber 90. The opening of the drier 5 is blocked with a gate shutter 5A.

The coater 6 is connected to the transfer chamber 90. The coater 6 has an opening facing the space 9A of the transfer chamber 90. The opening of the coater 6 is blocked with the gate shutter 6A.

The surface modifier 7 is connected to the transfer chamber 90. The surface modifier 7 has an opening facing the space 9A of the transfer chamber 90. The opening of the surface modifier 7 is blocked with the gate shutter 7A.

The load lock chamber 8 is connected to the transfer chamber 90. The load lock chamber 8 includes: an opening provided facing the transfer chamber 90; and the transfer gate 8B. The opening of the load lock chamber 8 is blocked with the gate shutter 8A. The coater 6, the drier 5, the surface modifier 7 and the load lock chamber 8 are consecutively connected in an anticlockwise order around the space 9A of the transfer chamber 90.

The structure and the operation of the coater 6, the drier 5, the surface modifier 7 and the load lock chamber 8 are the same as those in the first exemplary embodiment.

### Manufacturing Method of Gas Barrier Film

In a manufacturing method of the gas barrier layer-formed product (gas barrier film) according to the third exemplary embodiment, the manufacturing device 50 of the gas barrier film is used as a gas barrier layer-manufacturing device. The molded product 3 in the third exemplary embodiment is a thin plate-like component.

The manufacturing method of the gas barrier film according to the third exemplary embodiment includes: coating the surface of the molded product 3 with the gas barrier material in the coater 6; transferring the molded product 3 coated with the gas barrier material into the transfer chamber 90 through the transfer opening of the drier 5 and transferring the molded product 3 transferred from the coater 6 into the drier 5 through the transfer opening of the drier 5; drying the coated gas barrier material in the drier 5; after the gas barrier material is dried, transferring the molded product 3 into the transfer chamber 90 through the transfer opening of the drier 5 and transferring the molded product 3 transferred from the drier 5 into the surface modifier 7 through the transfer opening of the surface modifier 7; and modifying a surface of the dried gas barrier material in the surface modifier 7.

An example of the manufacturing method of the gas barrier film using the manufacturing device 50 of the gas barrier film will be described below.

In the third exemplary embodiment, since a procedure from the step of carrying the molded product 3 into the load lock chamber 8 to the step of coating the surface of the molded product 3 of the coater 6 with the gas barrier material (i.e., coating step) is the same as in the first exemplary embodiment, an explanation of the procedure will be omitted.

After the coating step is finished, the transfer robot 9 carries the molded product 3 to a front of the drier 5. After the gate shutter 5A is opened, the transfer robot 9 carries the molded product 3 into the drier 5 and further places the molded product 3 at a predetermined position. The gas barrier layer 2 is dried in the drier 5. Heating conditions in the drier 5 are the same as those in the first exemplary embodiment.

After drying of the gas barrier layer 2 in the drier 5 is finished, the gate shutter 5A is opened, the transfer robot 9 carries the molded product 3 out of the drier 5 and then carries the molded product 3 into the surface modifier 7, where plasma ions injection is performed in the same manner as in the first exemplary embodiment.

After the plasma ion injection is finished, a step of taking out the gas barrier film 1 through the transfer gate 8B is the same as in the first exemplary embodiment, an explanation of the step will be omitted.

According to the third exemplary embodiment, the same operation and the advantages as in the first exemplary embodiment are obtainable.

Further, with the manufacturing device according to the third exemplary embodiment, after the surface modification step, the gas barrier film can be taken out of the manufacturing device through the transfer chamber 90 and the load lock chamber 8 without passing through the drier 5.

### [5] Fourth Exemplary Embodiment

Next, a fourth exemplary embodiment of the invention will be described. It should be noted that an explanation of components identical to the components already explained will be omitted herein below.

### Manufacturing Device of Gas Barrier Film

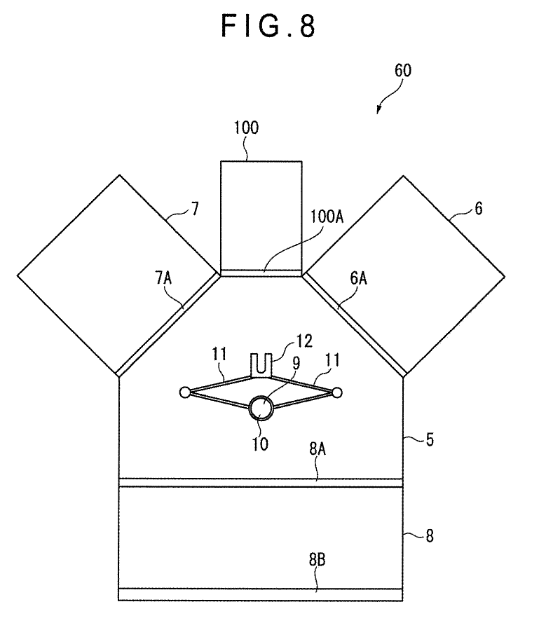

FIG. 8 shows a schematic plan view of a structure of a manufacturing device 60 of a gas barrier film according to the fourth exemplary embodiment.

The manufacturing device 60 of the gas barrier film is mainly different from the manufacturing device 4 of the gas barrier film according to the first exemplary embodiment in that the manufacturing device 60 includes a measuring unit 100 for measuring the gas barrier layer 2.

The manufacturing device 60 of the gas barrier film includes the drier 5 set in the middle of the manufacturing device, the coater 6, the surface modifier 7, the load lock chamber 8, and the measuring unit 100. A pair of arms of the transfer robot 9 are expandable in a direction away from the column 10. By expanding the arms 11, the molded product 3 mounted on the platform 12 can be carried into the coater 6, the surface modifier 7, the measuring unit 100, and the load lock chamber 8.

The structure and the operation of the coater 6, the drier 5, the surface modifier 7 and the load lock chamber 8 are the same as those in the first exemplary embodiment.

The measuring unit 100 is configured to measure at least one of the gas barrier material applied by the coater 6, the gas barrier material dried in the drier 5, and the gas barrier material modified in the surface modifier 7. In other words, the measuring unit 100 measures the gas barrier layer 2 formed on the molded product 3.

The measuring unit 100 is connected to the drier 5. As shown in FIG. 8, a connection portion between the measuring unit 100 and the drier 5 is positioned between a connection portion between the coater 6 and the drier 5 and a connection portion between the surface modifier 7 and the drier 5.

The measuring unit 100 has an opening facing the drier 5. The opening of the drier 100 is blocked with a partition in a form of a gate shutter 100A.

A measurement item(s) of the gas barrier layer 2 by the measuring unit 100 is preferably at least one measurement item selected from the group consisting of a refractive index, light transmissivity, light reflectivity, chromaticity, film composition, film density, film defects and film thickness.

A refractive index of the gas barrier layer 2 can be measured according to spectroscopic ellipsometry.

A light transmissivity of the gas barrier layer 2 can be measured according to a spectral transmittance measurement method.

A light reflectivity of the gas barrier layer 2 can be measured according to a spectral reflectance measurement method.

A chromaticity of the gas barrier layer 2 can be measured according to spectral colorimetry.

A film composition of the gas barrier layer 2 can be measured according to at least one of an XPS measurement method (X-ray photoelectron spectroscopy) and an IR measurement method (infrared spectroscopy). XPS is an abbreviation of X-ray Photoelectron Spectroscopy. IR is an abbreviation of Infrared Spectroscopy.

A film density of the gas barrier layer 2 can be measured according to an XRR measurement method (X-ray reflection measurement method). XRR is an abbreviation of X-ray Reflection.

Film defects of the gas barrier layer 2 can be measured according to a method of taking an image of the gas barrier layer 2 using at least one of a transmitted light and a reflected light and subjecting the taken image of the gas barrier layer 2 to an image processing.

A film thickness of the gas barrier layer 2 can be measured according to at least one of the spectroscopic ellipsometry, the spectral reflectance measurement method, fluorescent X-ray spectroscopy, and a measurement method using a contact step gauge.

A measuring device (not shown) is housed inside the measuring unit 100. The measuring device is appropriately selected depending on the measurement items and the measurement methods. The measuring device housed inside the measuring unit 100 is not limited to a single type. It is only necessary that an appropriate measurement device(s) required according to a type and the number of the measurement items is housed inside the measuring unit 100.

A controller (not shown) such as a computer is connected to the manufacturing device 60 of the gas barrier film in the same manner as in the first exemplary embodiment. The controller in the fourth exemplary embodiment can conduct not only the control explained in the first exemplary embodiment but also, for instance, a control of the measuring device of the gas barrier layer 2 in the measuring unit 100 and collection and analysis of measurement data.

### Manufacturing Method of Gas Barrier Film

In a manufacturing method of the gas barrier layer-formed product (gas barrier film) according to the exemplary embodiment, the manufacturing device 60 of the gas barrier film is used as a gas barrier layer-manufacturing device. The molded product 3 in the fourth exemplary embodiment is a thin plate-like component.

In addition to the steps of the manufacturing method described in the first exemplary embodiment, the manufacturing method of the gas barrier film according to the fourth exemplary embodiment further includes measuring at least one of the gas barrier material applied by the coater 6, the gas barrier material dried by the drier 5, and the gas barrier material modified by the surface modifier 7.

In the manufacturing method of the gas barrier film according to the fourth exemplary embodiment, it is preferable to measure the gas barrier material before the gas barrier material is modified in the surface modifier 7.

An example of the manufacturing method of the gas barrier film using the manufacturing device 60 of the gas barrier film will be described below.

In the fourth exemplary embodiment, since a procedure from the step of carrying the molded product 3 into the load lock chamber 8 to the step of drying the gas barrier layer 2 in the drier 5 is the same as in the first exemplary embodiment, an explanation of the procedure will be omitted.

After the drying in the drier 5 is finished, the transfer robot 9 carries the molded product 3 to a front of the measuring unit 100. After the gate shutter 100A is opened, the transfer robot 9 carries the molded product 3 into the measuring unit 100 and further places the molded product 3 at a predetermined position. The gas barrier layer 2 is measured in the measuring unit 100. Measurement items to be measured after the gas barrier layer 2 is dried and before the gas barrier layer 2 is subjected to the surface modification are as described above.

After the gas barrier layer 2 is dried and before the gas barrier layer 2 is subjected to the surface modification, it is preferable to measure a modified polysilazane layer and control a progress degree of a conversion reaction of a polysilazane film and a coating film thickness.

The progress degree of the conversion reaction can be checked by measuring at least one of a refractive index, light reflectivity, film composition and film density of the modified polysilazane layer. It is preferable to check the progress degree of the conversion reaction of the polysilazane film by measuring the refractive index. Data on the refractive index obtained by the refractive index measurement is preferably fed back to the above-described controller. In this arrangement, the controller can suitably control the heating conditions in the drier 5 based on the refractive index data.

It is preferable that the refractive index of the modified polysilazane layer after the gas barrier layer 2 is dried and before the gas barrier layer 2 is subjected to the surface modification is controlled in a range from 1.48 to 1.70.

By controlling the refractive index of the modified polysilazane layer within the above range, a gas barrier film having the gas barrier layer 2 excellent in the gas barrier property (e.g., a steam transmissivity), transparency (e.g., total light transmissivity) and the like can be obtained with the plasma ion injection in the surface modification step. When the refractive index of the modified polysilazane layer is less than 1.48, the steam transmissivity and an oxygen transmissivity of the gas barrier film sometimes become excessively high. When the refractive index of the modified polysilazane layer exceeds 1.70, the transparency (total light transmissivity) of the gas barrier film is sometimes excessively lowered or the gas barrier film is sometimes colored.

It is more preferable that the refractive index of the modified polysilazane layer after the gas barrier layer 2 is dried and before the gas barrier layer 2 is subjected to the surface modification is controlled in a range from 1.49 to 1.65, further preferably in a range from 1.50 to 1.60.

After the measurement of the gas barrier layer 2 is finished, the gate shutter 100A is opened and the transfer robot 9 transfers the molded product 3 from the measuring unit 100 into the surface modifier 7.

In the fourth exemplary embodiment, since the plasma ion injection in the surface modifier 7 is the same as in the first exemplary embodiment, an explanation of the plasma ion injection will be omitted.

After the surface modification, the transfer robot 9 transfers the molded product 3 from the surface modifier 7 to the measuring unit 100 and measures the gas barrier layer 2 subjected to the surface modification.

A modification degree of the modified polysilazane layer can be checked by measuring at least one of the refractive index, light transmissivity, light reflectivity, chromaticity, film composition and film density of the modified polysilazane layer. The modification degree of the modified polysilazane layer is preferably checked by measuring the light transmissivity. Data on the light transmissivity obtained by the light transmissivity measurement is preferably fed back to the above-described controller. In this arrangement, the controller can suitably control conditions for the plasma ion injection in the surface modifier 7 based on the light transmissivity data.

After the measurement of the gas barrier layer 2 is finished, the transfer robot 9 transfers the molded product 3 from the measuring unit 100. Since a subsequent procedure until the step of taking out the gas barrier film 1 through the transfer gate 8B is the same as in the first exemplary embodiment, an explanation of the subsequent procedure will be omitted.

In a process of using the polysilazane material as a precursor of the gas barrier layer and conducting the surface modification by injecting ions, thereby forming the gas barrier layer, it is considered that a film state after the ion injection (after the surface modification) greatly depends on a state of the modified polysilazane layer before the ion injection (i.e., after the coating and before the surface modification). It is considered that a control of the film state after the surface modification is an important test item for judging effectiveness of the surface modification.

According to the fourth exemplary embodiment, the same operation and the advantages as in the first exemplary embodiment are obtainable.

Further, according to the fourth exemplary embodiment, the state of the gas barrier layer can be measured in a manufacture line from the coating step through the drying step to the modification step (i.e., in-line measurement). By constantly controlling the film state in the manufacture line of the gas barrier film, the film can be continuously evaluated and controlled and the gas barrier film can be continuously manufactured in a series from the coating of the gas barrier material to the ion injecting.

Furthermore, according to the fourth exemplary embodiment, after the gas barrier layer 2 is dried and before the gas barrier layer 2 is subjected to the surface modification, the progress degree of the conversion reaction of the polysilazane film and the coating film thickness of the polysilazane film can be suitably controlled. Consequently, according to the fourth exemplary embodiment, the gas barrier film having the gas barrier layer 2 excellent in the gas barrier property (e.g., a steam transmissivity), transparency (e.g., total light transmissivity) and the like can be obtained.

Still further, according to the fourth exemplary embodiment, the drier 5, the coater 6, the surface modifier 7, and the measuring unit 100 are separated from each other by the gate shutters as the partitions. Accordingly, it is easy to keep the inside of the measuring unit 100 in a state suitable for the measurement, so that accuracy and quickness of the measurement can be improved.

### [6] Fifth Exemplary Embodiment

Next, a fifth exemplary embodiment of the invention will be described. It should be noted that an explanation of components identical to the components already explained will be omitted herein below.

### Manufacturing Device of Gas Barrier Film

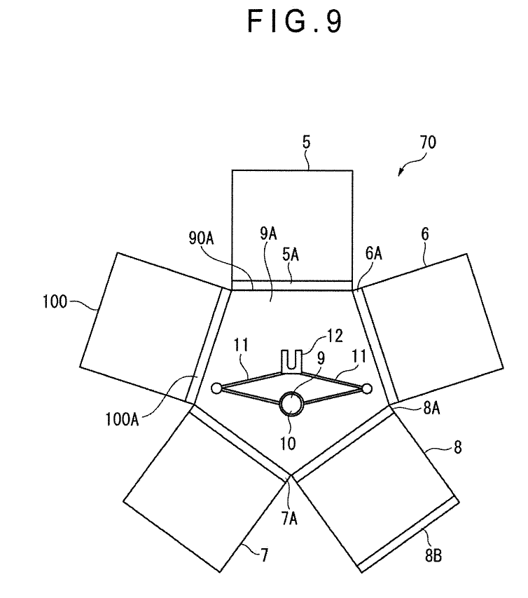

FIG. 9 shows a schematic plan view of a structure of a manufacturing device 70 of a gas barrier film according to the fifth exemplary embodiment.

The manufacturing device 70 of the gas barrier film is mainly different from the manufacturing device 50 of the gas barrier film according to the third exemplary embodiment in that the manufacturing device 70 includes the measuring unit 100 for measuring the gas barrier layer 2.

The manufacturing device 70 of the gas barrier film includes a transfer chamber 90A provided in the middle of the manufacturing device, the drier 5, the coater 6, the surface modifier 7, the load lock chamber 8, and the measuring unit 100.

The structure and the operation of the coater 6, the drier 5, the surface modifier 7 and the load lock chamber 8 are the same as those in the first or the third exemplary embodiment. The structure and the operation of the measuring unit 100 and the measurement items of the gas barrier layer 2 in the measuring unit 100 are the same as those in the fourth exemplary embodiment. A controller (not shown) such as a computer is connected to the manufacturing device 70 of the gas barrier film in the same manner as in the fourth exemplary embodiment.

In the manufacturing device 70 of the gas barrier film, the transfer chamber 90A, the coater 6, the drier 5, the surface modifier 7, the load lock chamber 8, and the measuring unit 100 are consecutively connected.

The transfer chamber 90A is formed substantially in a pentagon in a plan view as shown in the schematic plan view of FIG. 9. An inside of the transfer chamber 90A is defined as the space 9A. The transfer robot 9 is disposed in the space 9A. A pair of arms of the transfer robot 9 are expandable in a direction away from the column 10. By expanding the arms 11, the molded product 3 mounted on the platform 12 can be carried into the coater 6, the drier 5, the surface modifier 7, the measuring unit 100, and the load lock chamber 8.

In the fifth exemplary embodiment, the coater 6, the drier 5, the surface modifier 7, the load lock chamber 8, and the measuring unit 100 are respectively connected to portions of the transfer chamber 90A corresponding to sides of the substantial pentagon in a plan view. The coater 6, the drier 5, the surface modifier 7, the load lock chamber 8, and the measuring unit 100 respectively have openings facing the space 9A of the transfer chamber 90A. The respective openings of the coater 6, the drier 5, the surface modifier 7, the load lock chamber 8, and the measuring unit 100 are respectively blocked with the gate shutter 6A, the gate shutter 5A, the gate shutter 7A, the gate shutter 8A, and the gate shutter 100A.

### Manufacturing Method of Gas Barrier Film

In a manufacturing method of the gas barrier layer-formed product (gas barrier film) according to the exemplary embodiment, the manufacturing device 70 of the gas barrier film is used as a gas barrier layer-manufacturing device. The molded product 3 in the fifth exemplary embodiment is a thin plate-like component.

In addition to the steps of the manufacturing method described in the third exemplary embodiment, the manufacturing method of the gas barrier film according to the fifth exemplary embodiment further includes measuring at least one of the gas barrier material applied by the coater 6, the gas barrier material dried by the drier 5, and the gas barrier material modified by the surface modifier 7. Further, in the manufacturing method of the gas barrier film according to the fifth exemplary embodiment, the molded product 3 is transferred to the measuring unit 100 when measuring the gas barrier material.

In the manufacturing method of the gas barrier film according to the fifth exemplary embodiment, it is preferable to measure the gas barrier material before the gas barrier material is modified in the surface modifier 7.

An example of the manufacturing method of the gas barrier film using the manufacturing device 70 of the gas barrier film will be described below.

In the fifth exemplary embodiment, since a procedure from the step of carrying the molded product 3 into the load lock chamber 8 to the step of drying the gas barrier layer 2 in the drier 5 is the same as in the third exemplary embodiment, an explanation of the procedure will be omitted.

After the drying step is finished, the transfer robot 9 carries the molded product 3 to a front of the measuring unit 100. After the gate shutter 100A is opened, the transfer robot 9 carries the molded product 3 into the measuring unit 100 and further places the molded product 3 at a predetermined position. Since the measurement in the measuring unit 100 is the same as in the fourth exemplary embodiment, an explanation of the measurement will be omitted.

Since steps subsequent to the measurement of the gas barrier layer 2, specifically, the step of injecting plasma ions in the surface modifier 7 and the step of measuring the gas barrier layer 2 after the surface modification and taking out the gas barrier film 1 through the transfer gate 8B are the same as in the previous exemplary embodiments, an explanation of the step will be omitted.

Even in the fifth exemplary embodiment, the same operation and the advantages as in the first and fourth exemplary embodiments are obtainable.

Further, with the manufacturing device 70 according to the fifth exemplary embodiment, after the measurement in the measuring unit 100 and the surface modification step, the gas barrier film can be taken out of the manufacturing device through the transfer chamber 90 and the load lock chamber 8 without passing through the drier 5.

### [7] Sixth Exemplary Embodiment

Next, a sixth exemplary embodiment of the invention will be described. It should be noted that an explanation of components identical to the components already explained will be omitted herein below.

### Manufacturing Device of Gas Barrier Film

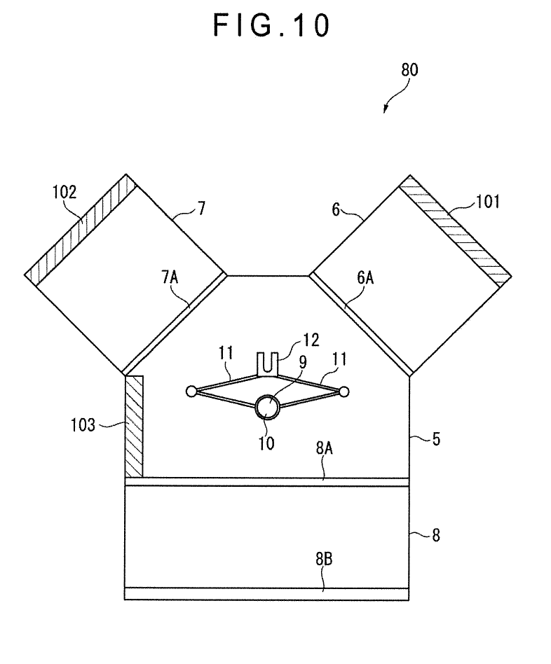

FIG. 10 shows a schematic plan view of a structure of a manufacturing device 80 of a gas barrier film according to the sixth exemplary embodiment.

The manufacturing device 80 of the gas barrier film in the sixth exemplary embodiment is mainly different from the manufacturing device 4 of the gas barrier film according to the first exemplary embodiment in that the manufacturing device 80 includes measuring units 101, 102 and 103 for measuring the gas barrier layer 2. The structure and the operation of the coater 6, the drier 5, the surface modifier 7 and the load lock chamber 8 are the same as those in the first exemplary embodiment.

Moreover, the sixth exemplary embodiment is mainly different from the fourth exemplary embodiment and the fifth exemplary embodiment in that the coater 6, the drier 5, and the surface modifier 7 house the respective measuring units in the manufacturing device 80 of the gas barrier film according to the sixth exemplary embodiment, whereas the measuring unit 100 is independent of the coater 6, the drier 5, and the surface modifier 7 in the manufacturing device of the gas barrier film in the fourth and fifth exemplary embodiments.

In the manufacturing device 80 of the gas barrier film, the coater 6 has the measuring unit 101, the drier 5 has the measuring unit 103, and the surface modifier 7 has the measuring unit 102.

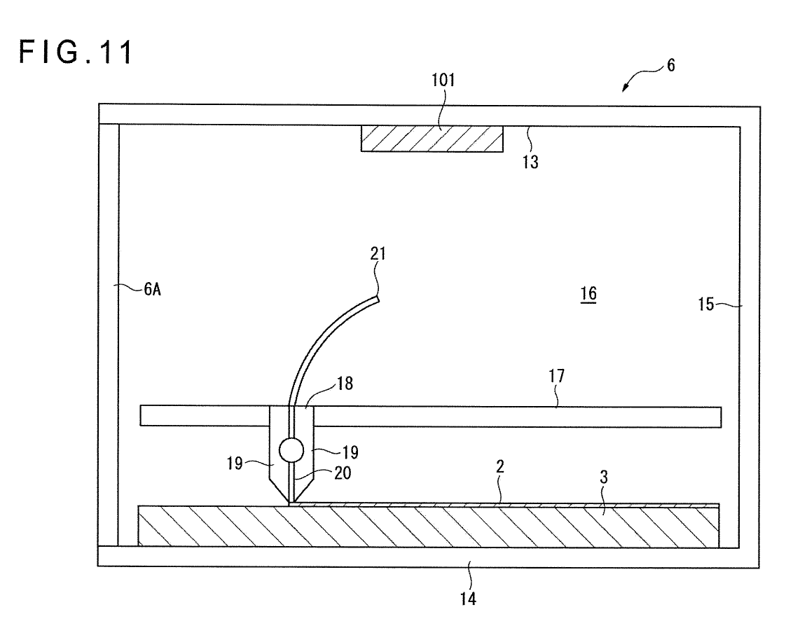

A setting position of the measuring unit 101 is not particularly limited, as long as the measuring unit 101 is set inside the coater 6. It is only required to select the setting position depending on the measurement items in the coater 6. For instance, as shown in FIG. 11, the measuring unit 101 may be attached to the top board 13 of the coater 6.

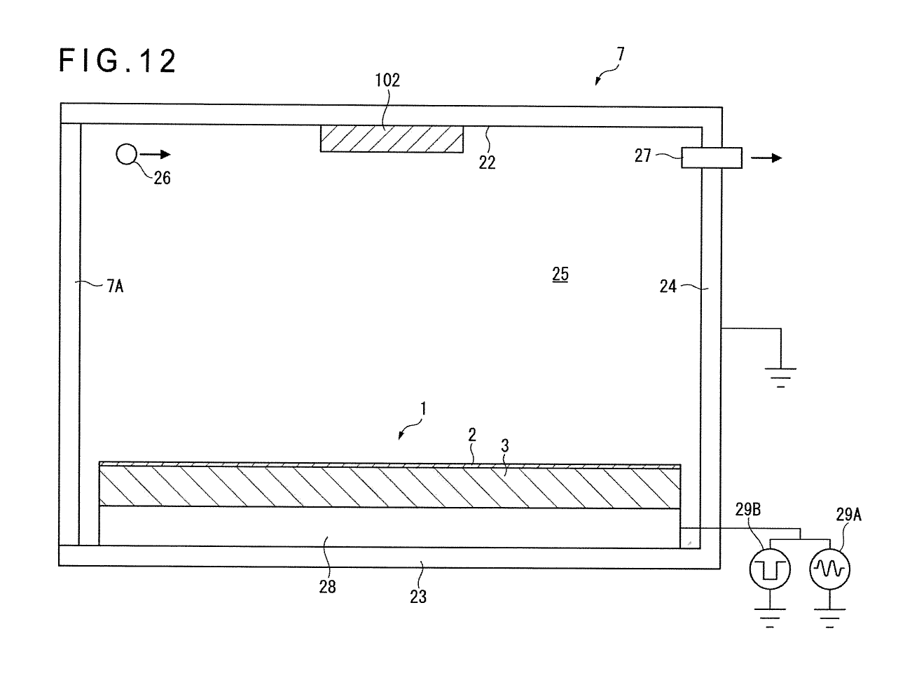

A setting position of the measuring unit 102 is not particularly limited, as long as the measuring unit 102 is set inside the surface modifier 7. It is only required to select the setting position depending on the measurement items in the surface modifier 7. For instance, as shown in FIG. 12, the measuring unit 102 may be attached to the top board 22 of the surface modifier 7.

The measuring units 101, 102 and 103 are not limited to the measuring unit 100 as long as the measuring units 101, 102 and 103 can measure the same measurement items as those of the measuring unit 100. For instance, a measuring device similar to the measuring device used as the measuring unit 100 is also usable as the measuring units 101, 102 and 103. A controller (not shown) such as a computer is connected to the manufacturing device 80 of the gas barrier film in the same manner as in the fourth exemplary embodiment.

### Manufacturing Method of Gas Barrier Film

In a manufacturing method of the gas barrier layer-formed product (gas barrier film) according to the exemplary embodiment, the manufacturing device 80 of the gas barrier film is used as a gas barrier layer-manufacturing device. The molded product 3 in the sixth exemplary embodiment is a thin plate-like component.

In addition to the steps of the manufacturing method described in the first exemplary embodiment, the manufacturing method of the gas barrier film according to the sixth exemplary embodiment further includes measuring at least one of the gas barrier material applied by the coater 6, the gas barrier material dried by the drier 5, and the gas barrier material modified by the surface modifier 7. In the manufacturing method of the gas barrier film according to the sixth exemplary embodiment, at least one of the measuring units housed in the drier 5, the coater 6 and the surface modifier 7 measures the gas barrier material.

In the manufacturing method of the gas barrier film according to the sixth exemplary embodiment, it is preferable to measure the gas barrier material before the gas barrier material is modified in the surface modifier 7.

An example of the manufacturing method of the gas barrier film using the manufacturing device 80 of the gas barrier film will be described below.

The manufacturing device 80 of the gas barrier film is different from the manufacturing device 4 of the gas barrier film according to the first exemplary embodiment in that at least one of the measuring units 101, 102 and 103 can measure the gas barrier layer 2.

The measuring unit 101 of the coater 6 preferably measures a film thickness of the gas barrier layer 2 before the gas barrier layer 2 is dried.

The measuring unit 102 of the drier 5 can measure the gas barrier layer 2 before and after the gas barrier layer 2 is subjected to the surface modification.

The measuring unit 103 of the surface modifier 7 can measure the gas barrier layer 2 before and after the gas barrier layer 2 is subjected to the surface modification.

In the sixth exemplary embodiment, the same operation and the advantages as in the first and fourth exemplary embodiments are obtainable.

Further, in the manufacturing method of the gas barrier film according to the sixth exemplary embodiment, since the measuring units are respectively housed in the drier 5, the coater 6 and the surface modifier 7, the measurement can be quickly started each time the processing is finished in each of the drier 5, the coater 6 and the surface modifier 7.

### [8] Seventh Exemplary Embodiment

Next, a seventh exemplary embodiment of the invention will be described. It should be noted that an explanation of components identical to the components already explained will be omitted herein below.

### Manufacturing Device of Gas Barrier Film

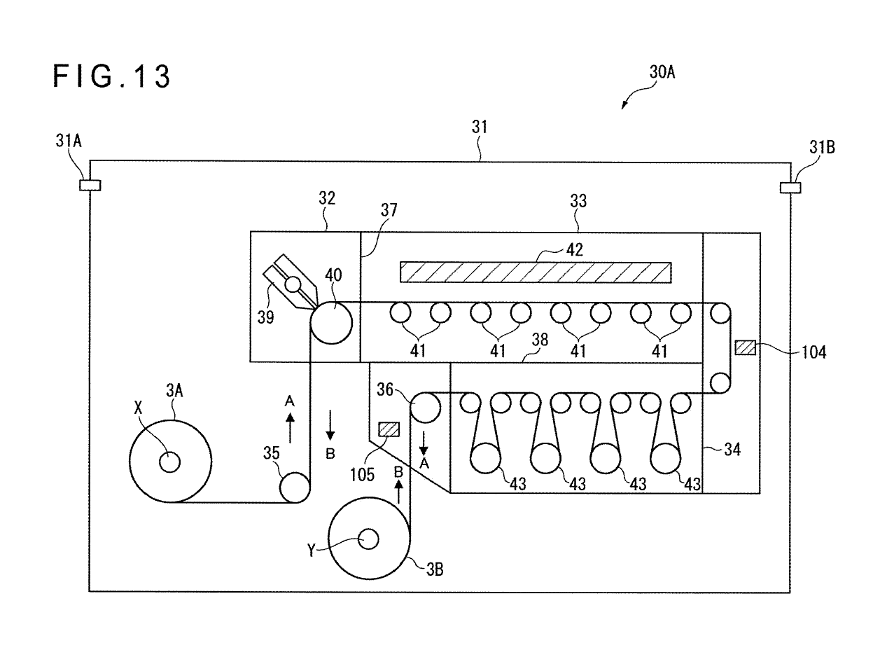

FIG. 13 shows a schematic view of a structure of a manufacturing device 30A of a gas barrier film according to the seventh exemplary embodiment.

The manufacturing device 30A of the gas barrier film has the same structure as that of the manufacturing device 30 of the gas barrier film according to the second exemplary embodiment, and further includes a measuring unit 104 and a measuring unit 105. The measuring unit 104 is disposed between the drier 33 and the surface modifier 34. The measuring units 104 and 105 may have any arrangement as long as the measuring units 104 and 105 can measure the same measurement item as those of the measuring unit 100. For instance, a measuring device similar to the measuring device used as the measuring unit 100 is also usable as the measuring units 104 and 105.

In the manufacturing device 30A of the gas barrier film, the structure and the operation of the chamber 31, the coater 32, the drier 33, the surface modifier 34, the drive roller 35, the drive roller 36, the partition 37, and the partition 38 are the same as those in the second exemplary embodiment.

A controller (not shown) such as a computer is also connected to the manufacturing device 30A of the gas barrier film in the same manner as in the second exemplary embodiment.

### Manufacturing Method of Gas Barrier Film

In a manufacturing method of the gas barrier layer-formed product (an elongated gas barrier film) according to the exemplary embodiment, the manufacturing device 30A of the gas barrier film is used as a gas barrier layer-manufacturing device.

In addition to the steps of the manufacturing method described in the second exemplary embodiment, the manufacturing method of the elongated gas barrier film according to the seventh exemplary embodiment further includes measuring at least one of the gas barrier material applied by the coater 6, the gas barrier material dried by the drier 5, and the gas barrier material modified by the surface modifier 7.

In the manufacturing method of the gas barrier film according to the seventh exemplary embodiment, it is preferable to measure the gas barrier material before drying the gas barrier material applied by the coater 6.

An example of the manufacturing method of the elongated gas barrier film using the manufacturing device 30A of the gas barrier film will be described below.

Since the seventh exemplary embodiment is the same as in the second exemplary embodiment except for the measurement in the measuring units 104 and 105, an explanation of the same structure will be omitted.

While the elongated base material 3A after being dried in the drier 33 is transferred toward the surface modifier 34, the measuring unit 104 measures the gas barrier layer 2 (the modified polysilazane layer) before being subjected to the surface modification. Also while the elongated base material 3B after being subjected to the surface modification 34 by the surface modifier 34 is transferred toward the drier 33, the measuring unit 104 can measure the gas barrier layer 2 after being subjected to the surface modification.

The measuring unit 105 is disposed between the surface modifier 34 and the winding shaft Y. After the elongated base material 3A is subjected to the surface modification in the surface modifier 34 and before the elongated base material 3A is wound around the winding shaft Y, the measuring unit 105 measures the gas barrier layer 2 after being subjected to the surface modification.

According to the seventh exemplary embodiment, the following advantages are obtainable in addition to the above-described advantages of the second exemplary embodiment.

With the manufacturing device and the manufacturing method according to the exemplary embodiment, the gas barrier material of the elongated base material 3A can be measured while the elongated base material 3A is transferred from the drier 33 to the surface modifier 34. Accordingly, it can be checked in advance whether the gas barrier layer 2 is in a state suitable for the surface modification.

Further, with the manufacturing device and the manufacturing method according to the seventh exemplary embodiment, by constantly controlling the film state in a roll-to-roll manufacture line, the film can be continuously evaluated and controlled and the gas barrier film can be continuously manufactured in a series from the coating of the gas barrier material to the ion injecting.

Furthermore, with the manufacturing device and the manufacturing method according to the seventh exemplary embodiment, even in the roll-to-roll manufacture line, after the gas barrier layer 2 is dried and before the gas barrier layer 2 is subjected to the surface modification, the progress degree of the conversion reaction of the polysilazane film and the coating film thickness of the polysilazane film can be suitably controlled. Consequently, the gas barrier film having the gas barrier layer 2 excellent in the gas barrier property (e.g., a steam transmissivity), transparency (e.g., total light transmissivity) and the like can be manufactured by the roll-to-roll process.

### Modifications of Embodiments

It should be understood that the scope of the invention is not limited to the above-described exemplary embodiments but includes modifications and improvements compatible with the invention. It should be noted that components, the devices and the like identical to those already explained in the above exemplary embodiments are denoted by the same numerical signs and an explanation thereof will be omitted herein below.

In the above exemplary embodiments, the manufacturing method and the manufacturing device mainly for manufacturing the gas barrier film are described as an example, but the method and the device are not limited those for manufacturing the gas barrier film. The manufacturing method and the manufacturing device described in the above exemplary embodiments are applicable for the molded product in a form of various containers and various electronic device components.

The scope of the invention is not limited to the embodiment of forming a single gas barrier layer on the molded product, but encompasses an arrangement in which one or more gas barrier layers are further laminated on the formed gas barrier layer. With the manufacturing method and the manufacturing device of the gas barrier layer-formed product, a molded product having a gas barrier layer with a predetermined thickness can be manufactured by laminating the gas barrier layers.

For instance, in the first and third to sixth exemplary embodiments, after the gas barrier layer is formed, the molded product needs not to be carried out of the load lock chamber but may be again transferred to the coater, the drier, and the surface modifier in this order, whereby another gas barrier layer can be laminated on the previously formed gas barrier layer.

Alternatively, for instance, in the second and seventh exemplary embodiments, after the elongated base material subjected to the surface modification is wound around the winding roller, the elongated base material may be again fed in the A direction to be subjected to the processings in the coater and the drier, and further fed in the B direction to be subjected to the processing in the surface modifier, whereby another gas barrier layer can be laminated on the previously formed gas barrier layer.

When a plurality of gas barrier layers are laminated, it is also preferable that the measuring unit measures the film state of each of the gas barrier layers each time the gas barrier layer is formed.

In the fourth, fifth, sixth and seventh exemplary embodiments, it is described as an example that the measuring unit measures the gas barrier layer before and after the surface modification step. However, the scope of the invention is not limited to such embodiments.

It is only required to measure the gas barrier layer before the surface modification step and/or after the surface modification step. It is more preferable to at least measure the gas barrier layer after the gas barrier layer is dried and before the gas barrier layer is subjected to the surface modification.

In the sixth exemplary embodiment, it is described as an example that the coater, the drier, and the surface modifier have the respective measuring units. However, the scope of the invention is not limited to such an embodiment.

It is only required that the manufacturing device of the gas barrier film provided with the measuring unit includes a measuring unit in any one of the coater, the drier, and the surface modifier. In an arrangement where the measuring unit is not independent of the coater, the drier, and the surface modifier, at least one of the coater, the drier, and the surface modifier preferably includes the measuring unit. For instance, it is also preferable that the coater has the measuring unit but the drier and the surface modifier do not have the measuring unit. It is also preferable that the drier has the measuring unit but the coater and the surface modifier do not have the measuring unit. It is also preferable that the surface modifier has the measuring unit but the coater and the drier do not have the measuring unit. It is preferable to measure the modified polysilazane layer after the gas barrier layer is dried and before the gas barrier layer is subjected to the surface modification. In an arrangement allowing such a measurement, a setting position of the measuring unit is not particularly limited as long as the modified polysilazane layer is measurable.

In the seventh exemplary embodiment, the manufacturing device 30A of the gas barrier film having the measuring units 104 and 105 is described as an example. However, the scope of the invention is not limited to such an embodiment. For instance, it is preferable that such a roll-to-roll manufacturing device as shown in the third and seventh exemplary embodiments has at least one measuring unit. It is preferable to measure the modified polysilazane layer after the gas barrier layer is dried and before the gas barrier layer is subjected to the surface modification. In an arrangement allowing such a measurement, a setting position of the measuring unit in a roll-to-roll manufacturing device is not particularly limited as long as the modified polysilazane layer is measurable.

1. A manufacturing device of a molded product provided with a gas barrier layer, wherein the gas barrier layer is formed on a surface of the molded product, the manufacturing device comprising:
a coater configured to coat the molded product with a gas barrier material;
a drier configured to dry the gas barrier material applied by the coater;
a surface modifier configured to modify a surface of the gas barrier material dried in the drier, and
a transfer unit configured to transfer the molded product to the coater, the drier, and the surface modifier, wherein
the coater, the drier, and the surface modifier are consecutively connected, and
the coater, the drier, and the surface modifier are separated from each other by partitions.

2. The manufacturing device according to claim 1, further comprising:
a measuring unit configured to measure at least one of the gas barrier material applied by the coater, the gas barrier material dried by the drier, and the gas barrier material modified by the surface modifier.

3. The manufacturing device according to claim 2, wherein
the measuring unit is consecutively connected to the coater, the drier, and the surface modifier, and
the coater, the drier, the surface modifier, and the measuring unit are separated from each other by the partitions.

4. The manufacturing device according to claim 3, wherein
the molded product is transferred to the coater, the drier, and the measuring unit in this order.

5. The manufacturing device according to claim 2, wherein
the measuring unit is disposed inside at least one of the coater, the drier, and the surface modifier.

6. The manufacturing device according to claim 1, wherein
the drier is disposed at a center of the manufacturing device,
a transfer opening of the coater and a transfer opening of the surface modifier are positioned facing the drier, and
the transfer unit is disposed in the drier.

7. The manufacturing device according to claim 1, wherein
a transfer opening of the coater, a transfer opening of the drier, and a transfer opening of the surface modifier face a space in which the transfer unit is disposed.

8. The manufacturing device according to claim 1, wherein
the molded product is an elongated base material in a form of a roll,
the transfer unit comprises: a feeding roller configured to feed the elongated base material; and a winding roller configured to wind the elongated base material,
the coater comprises: a support roller supporting the elongated base material; and a die coater that is disposed opposite to the support roller across the elongated base material and is configured to coat the elongated base material with the gas barrier material, and
the drier comprises: a plurality of transfer rollers configured to transfer the elongated base material; and a heater disposed opposite to the plurality of transfer rollers across the elongated base material.

9. The manufacturing device according to claim 8, wherein
the surface modifier comprises: an electrode roller configured to be wound with the elongated base material; a voltage applying unit configured to apply a voltage onto the electrode roller; and an electrode disposed opposite to the electrode roller across the elongated base material.

10. The manufacturing device according to claim 8, further comprising:
a measuring unit configured to measure at least one of the gas barrier material applied by the coater, the gas barrier material dried by the drier, and the gas barrier material modified by the surface modifier.

11. The manufacturing device according to claim 10, wherein
the measuring unit is disposed between the drier and the surface modifier.

12. The manufacturing device according to claim 2, wherein
the measuring unit measures at least one selected from the group consisting of a refractive index, light transmissivity, light reflectivity, chromaticity, film composition, film density, film defects and film thickness of the gas barrier layer.

13. The manufacturing device according to claim 10, wherein
the measuring unit measures at least one selected from the group consisting of a refractive index, light transmissivity, light reflectivity, chromaticity, film composition, film density, film defects and film thickness of the gas barrier layer.
